(19) United States
(12) Patent Application Publication
(10) Pub. No.: US 2006/0153381 A1
(43) Pub. Date: Jul. 13, 2006

(54) Method and apparatus for writing and using keys for encrypting/decrypting a content and a recording medium storing keys written by the method

(76) Inventors: Byung Jin Kim, Kyunggi-do (KR); Sung Wan Park, Suwon-si (KR); Kang Soo Seo, Kyunggi-do (KR)

Correspondence Address: HARNESS, DICKEY & PIERCE, P.L.C., P.O. BOX 8910, RESTON, VA, 20195, US

(21) Appl. No.: 11/296,465

(22) Filed: Dec. 8, 2005

Related U.S. Application Data
(60) Provisional application No. 60/634,997, filed on Dec. 13, 2004.
(60) Provisional application No. 60/638,332, filed on Dec. 23, 2004.

(30) Foreign Application Priority Data
Nov. 5, 2005 (KR) 10-2005-0105753

(51) Int. Cl. H04N 7/167

(52) U.S. Cl. 380/228

(57) ABSTRACT

Content encryption information on content data recorded on a recording medium. A plurality of encryption keys used for encrypting a plurality of data clips containing content data is stored in a key file and index information for associating each of the plurality of encryption keys with a data segment encrypted with the encryption key is placed in the key file or in another management information file (e.g., clip information file). As a consequence, it is allowed to decrypt encrypted content data with different encryption keys by applying each of the plurality of encryption keys to each associated data segment.

### DOMESTIC PRIORITY INFORMATION

This application claims priority under 35 U.S.C. §119 on U.S. provisional application 60/634,997, filed Dec. 13, 2004, and 60/638,332, filed Dec. 23, 2004; the entire contents of which are hereby incorporated by reference.

### FOREIGN PRIORITY INFORMATION

This application claims priority from Korean Patent Application No. 10-2005-0105753, filed Nov. 5, 2005; the contents of which are hereby incorporated herein by reference in their entirety.

### BACKGROUND OF THE INVENTION

1. Field of the Invention

This document relates to a method for writing and using keys for copy-protecting a content recorded on a recording medium and a recording medium storing keys written by the method.

2. Description of the Related Art

The DVD-ROM, which is usually called the DVD, has a storage capacity of 4.7 GB and is commonly used as a storage medium for delivering high-quality digital contents such as movies.

TV stations currently broadcast in both analog and digital but only digital TV broadcast will be available in the near future. Digital broadcast provides better video quality over its analog counterpart. Viewers have a natural desire to enjoy movies of higher video quality than that of the DVD.

For this reason, read-only and rewritable disks having higher storage capacity than the DVD are under development. Higher-capacity disks can provide viewers with high-quality contents in various and easy ways.

The copyright of contents recorded on recording media such as optical disks is sometimes infringed by illegal copying. To prevent illegal copying, content data recorded on a recording medium is encrypted and the key used for the encryption is recorded in a particular area of the recording medium (e.g., an area that is not accessible by ordinary read operations) or the key itself or a method for obtaining the key is stored in a certified remote server.

In the case of the DVD, data organized as a title is encrypted using one key and the key is written to a 16-byte header, which is appended to each ECC (error correction code) block, once or twice.

More than one title may be recorded on a single DVD but the data of a title does not overlap with the data of another title. As a result, each title may be encrypted using different keys for enhancing copy protection.

In the case of higher-capacity disks, however, the data of titles recorded on a disk may partly overlap with each other and thus it is not allowed to encrypt content data recorded thereon in the same way as in the DVD.

### SUMMARY OF THE INVENTION

It is an object of the present invention to provide a data encryption method that allows different titles recorded on a recording medium to be encrypted/decrypted using different keys even in the case where data of the titles partly overlap with each other.

The present invention encrypts or decrypts data clips by selectively applying a plurality of encryption keys to the whole or partial data of each of the data clips.

The present invention stores a plurality of encryption keys used for encrypting a plurality of data clips in a key file and places index information for associating each of the plurality of encryption keys with a data segment encrypted with the encryption key in the key file or in another management information file.

In one embodiment of the invention, each of a plurality of encryption keys is used for encrypting or decrypting each of data blocks organized by dividing each of a plurality of data clips with the boundaries of data segments shared by multiple titles.

In another embodiment of the invention, each of a plurality of encryption keys is used for encrypting or decrypting each of a plurality of data clips.

In yet another embodiment of the invention, each of a plurality of encryption keys is used for encrypting or decrypting each of data segments pointed to by playitems included in titles.

In one embodiment of the invention, the index information is written in the clip information file storing information on each data clip.

In another embodiment of the invention, the index information is written in the key file storing encryption keys.

In one embodiment of the invention, each index information set comprises a pair of information for allowing the access to the associated key and a data clip file name.

In another embodiment of the invention, each index information set comprises a pair of the associated key and a data clip file name.

In one embodiment of the invention, an index information set is created for each of data clips belonging to each title.

In another embodiment of the invention, an index information set is created for each of playitems belonging to each title.

In one embodiment of the invention, a plurality of encryption keys is obtained from a recording medium having content data thereon.

In another embodiment of the invention, a plurality of encryption keys is obtained from an external server through a network.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 illustrates an exemplary relation between a plurality of titles and a plurality of data clip files;

FIG. 2 illustrates a block diagram of an apparatus for manufacturing read-only recording media having encryption information in accordance with an embodiment of the present invention;

FIG. 3 illustrates an exemplary relation between a plurality of titles and a plurality of data clip files in which a different encryption key is applied to each of data segments divided in accordance with one embodiment of the present invention;

FIG. 4 illustrates a data structure for storing encryption information in accordance with the embodiment shown in FIG. 3;

FIG. 5 illustrates an exemplary relation between a plurality of titles and a plurality of data clip files in which a different encryption key is applied to each of data segments divided in accordance with another embodiment of the present invention;

FIGS. 6a and 6b illustrate data structures for storing encryption information in accordance with the embodiment shown in FIG. 5;

FIG. 7 illustrates an exemplary relation between a plurality of titles and a plurality of data clip files in which a different encryption key is applied to each of data segments divided in accordance with yet another embodiment of the present invention;

FIGS. 8a, 8b, and 8c illustrate data structures for storing encryption information in accordance with the embodiment shown in FIG. 7; and

FIG. 9 illustrates a block diagram of an apparatus for reproducing a recording medium storing encrypted content data and encryption information in accordance with an embodiment of the present invention.

### DETAILED DESCRIPTION OF EXAMPLE EMBODIMENTS

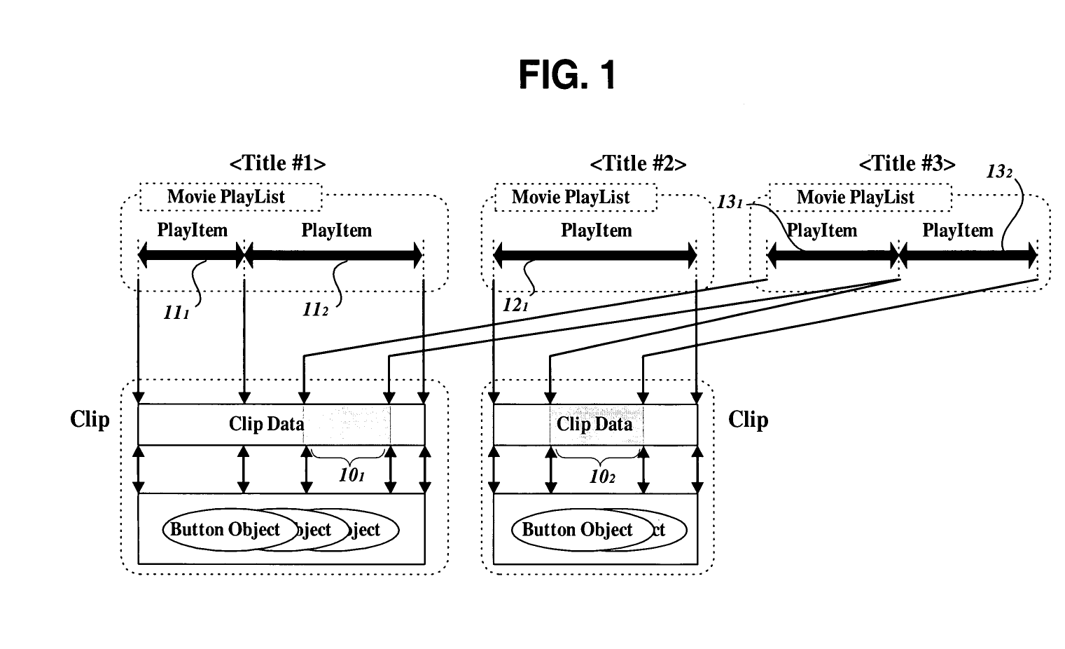

Higher-capacity disk media (e.g., Blu-ray Disk ROM, BD-ROM in short) do not manage each clip file containing A/V data as a title, which is exemplified in FIG. 1. As shown, one movie playlist is managed as one title (logical continuous playback unit information) in the BD-ROM and each playitem included therein references the whole or a segment of a clip file. The segments of the clip file that correspond to playitems may overlap. In FIG. 1, the data segment referenced by playitem 11₂ overlaps in part with the data segment referenced by playitem 13₁. Likewise, the data segment referenced by playitem 12₁, overlaps in part with the data segment referenced by playitem 13₂. As a result, Title #1 and Title #3 have an overlapped segment 10₁ and Title #2 and Title #3 have an overlapped segment 10₂. Titles having overlapped segments cannot be encrypted using different keys. If two titles sharing the same segment are encrypted with different keys, the shared segment should be decrypted with two different keys. For example, the overlapped segment 10₁ of Title #1 should be encrypted with two different keys and thus it should be decrypted twice using the two different keys. In other words, a segment shared by more than a title should be decrypted as many times as the number of the titles sharing the segment, which degrades the decoding performance of reproducing apparatuses significantly.

To solve the problem, content data of titles sharing the same data segment should be encrypted with the same key, which means all the titles shown in FIG. 1 should be encrypted with the same key because Title #1 and Title #2 share a data segment and Title #2 and Title #3 share a data segment. If it is not allowed to encrypt different titles with different keys in high-capacity recording media, the effectiveness of copy protection is seriously deteriorated.

In order that the invention may be fully understood, preferred embodiments thereof will now be described with reference to the accompanying drawings.

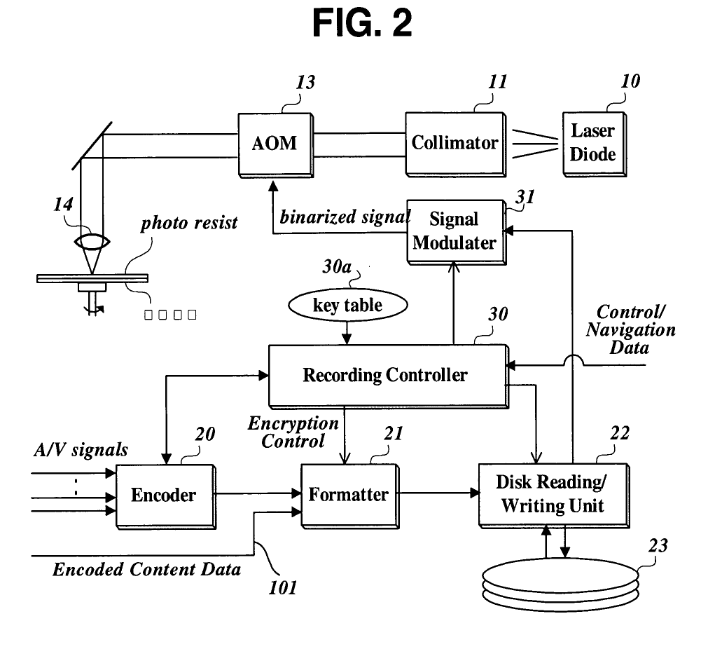

FIG. 2 is a block diagram of an apparatus for manufacturing read-only optical disks having encryption information in accordance with the present invention. The apparatus comprises a laser diode 10 for generating a laser beam, a collimator 11 for collimating the generated laser beam, an optical modulator 13 for passing or blocking the parallel beam from the collimator 11 depending on the level of a modulated input signal (e.g., EFM signal), a condensing lens 14 for concentrating the beam from the optical modulator 13 on a photosensitive layer (e.g., photo resist) located on a glass substrate, an encoder 20 for encoding input content data in a predefined format (e.g., the MPEG format), a formatter 21 for encrypting the encoded data with a key selected from a key table 30a and for formatting the encrypted data into ECC block data suitable for recording, a high-capacity storage medium 23 (e.g., hard disk drive) for storing data, a disk reading/writing unit 22 for reading/writing data from/to the storage medium 23, a signal modulator 31 for modulating data stored in the storage medium 23 into a binary signal such as EFM signal for recording on a disk, and a recording controller 30 for processing user input, for performing operations to copy-protect contents, for creating navigation data for contents being recorded, and for controlling the irradiation of the laser beam on the photosensitive layer.

To produce a read-only disk using the apparatus shown in FIG. 2, it is first required to write content data to be recorded on the read-only disk and navigation data for the content data to the storage medium 23. Before the content data is stored, the content data is encrypted by the method which will be described below. The recording controller 30 appends data required for mapping the data stored in the storage medium 23 to the read-only disk (e.g., key information and index information for key indexing) to the navigation information.

The data stored in the storage medium 23 is read under the control of the recording controller 30 and then modulated into a binary signal by the signal modulator 31. The optical modulator 13 passes or blocks the collimated laser beam depending on the level of the modulated signal, thereby forming a pit train corresponding to the modulated signal on the photosensitive layer located on the glass substrate. Controlled by the recording controller 30, the condensing lens 14 moves outward slowly during the pit-forming process, thereby making the pit train be a spiral pattern. The pit train represents data corresponding to the content data and navigation data therefor stored in the storage medium 23. A stamper is made using the photosensitive layer having the pit train thereon and read-only disks storing the content data encrypted according to the present invention and navigation data including encryption information are manufactured using the stamper.

Because the encrypted content data and navigation data including encryption information (i.e., encryption key information and index information for key indexing) stored in the storage medium 23 are directly mapped to the read-only disk, the data structure of the storage medium 23 is the same as the data structure of the read-only disk. Therefore, only the method of writing data to the storage medium 23 according to the present invention will now be described because the method also applies to the read-only disk.

The recording method according to the present invention also applies to rewritable disks (e.g., Blu-ray Disk Rewritable) in that the content data encrypted according to the present invention and navigation data including encryption information can also be recorded on a rewritable optical disk instead of the storage medium 23. In the case where the data is recorded on a rewritable disk, the recording controller 30 controls a servo control unit for moving optical recording means (e.g., optical pickup) to a position at which data will be recorded.

An input video signal is encoded in a particular format (e.g., the MPEG format) by the encoder 20 and converted into ECC blocks by the formatter 21 and then written to the storage medium 23 by the reading/writing unit 22. Also, a data stream 101 pre-encoded by another apparatus may be provided from another storage medium.

The encoder 20 encodes input content data into GOPs each of which comprises a leading I-picture and possibly more pictures. The recording controller 30 organizes one or more successive GOPs into a navigation unit such that the playback time duration thereof is between 0.4 and 1 second and creates navigation information for the navigation unit. Information necessary for the creation of the navigation units is provided by the encoder 20. One content is written as one or more clip files and video title set information (VTSI), which is management information for the recorded data, is created and written as a single file (e.g., Video_TS.ifo). The information required for creating the VTSI may be received from a user through a graphical user interface based menu preprogrammed in the recording controller 30.

The structure of management information including navigation data for the recorded content (e.g., index table, movie object, movie playlist, playitem, etc) is not the concern of the invention and thus will not be described here. The recording and reproduction methods in accordance with the invention will now be described in detail with an emphasis on encryption information required for encrypting each title with one key or a combination of keys.

The formatter 21 encrypts the content data encoded by the encoder 20 or provided from another storage medium 101 with encryption keys selected from the encryption key table 30a and converts the encrypted data into ECC block data suitable for recording. The ECC formatted encrypted data is written to the storage medium 23 by the disk reading/writing unit 22.

Each time the formatter 21 meets predetermined boundaries in the encoded data, the recording controller 30 selects an encryption key from the encryption key table 30a and provides the formatter 21 with the selected encryption key so that the formatter 21 can use the encryption key for encrypting data. The predetermined data boundaries, which are designated by data titles, data segments included in each title, or playitems, are stored in the recording controller 30.

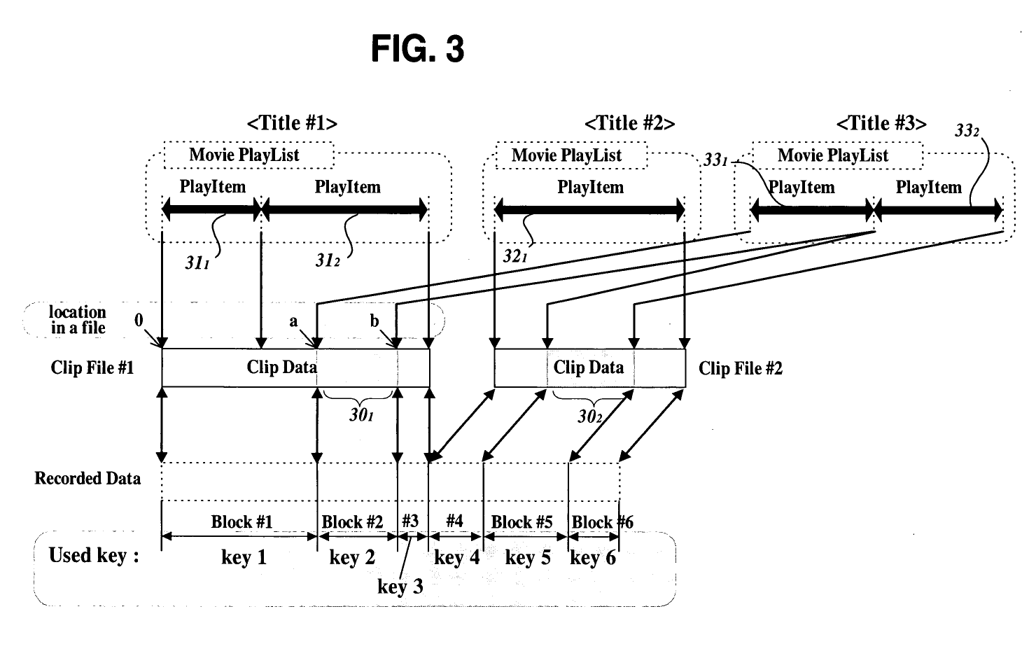

FIG. 3 shows an exemplary content recorded by applying a different encryption key to each of the data segments specified by the predetermined boundaries in accordance with one embodiment of the invention. Each of the data segments is referred to as a content protection system (CPS) unit.

In FIG. 3, if there is a data segment shared by different titles (each title corresponding to logical continuous playback unit information) in a clip file, different encryption keys are applied to data divided by the boundaries of the shared data section. The data of Clip File #1 has a data segment 30₁ shared by two different titles, which divides the data into three data blocks. The three data blocks, Block #1, Block #2, and Block #3 are encrypted using different keys, key 1, key 2, and key 3, respectively. Likewise, the data of Clip File #2 comprises three data blocks encrypted using three different encryption keys, key 4, key 5, and key 6. Each of the data blocks which belong to the same clip file but are encrypted with different encryption keys as shown in FIG. 3 is referred to as an advanced access content system (AACS) key sequence.

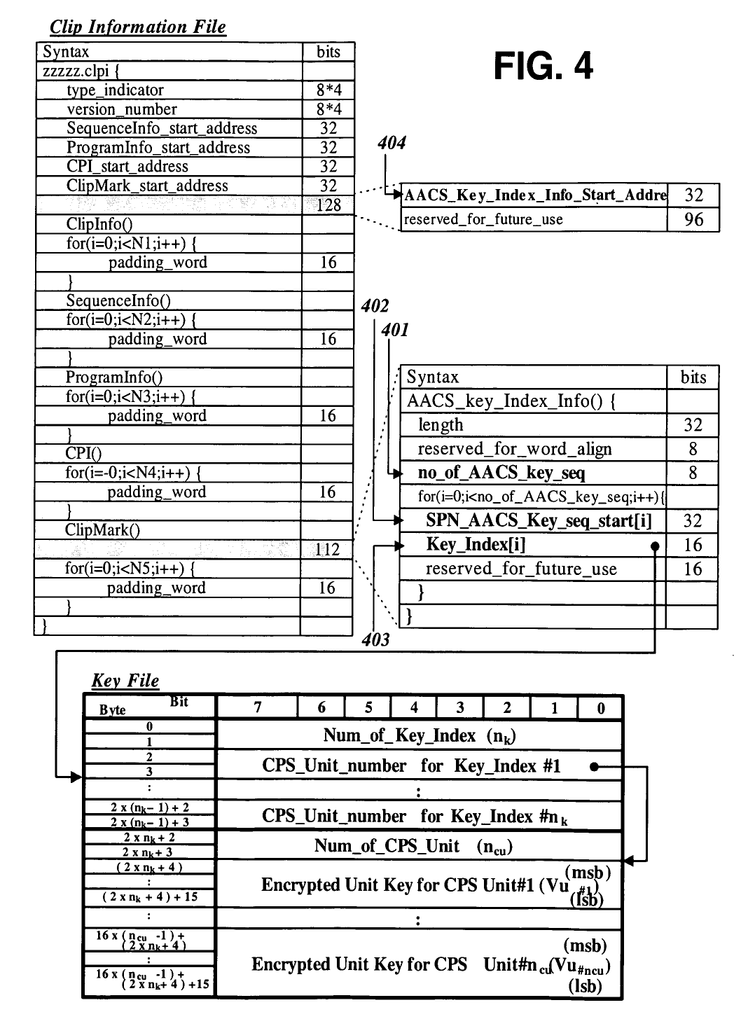

The encryption keys applied to AACS key sequences as shown in FIG. 3 are stored in a key file. The key file has a structure as shown in FIG. 4. Content protection system (CPS) unit numbers as key index information are placed in the former part of the key file and used keys are placed in the latter part thereof. The recording controller 30 creates an information field AACS_Key_Index_Info( ) to store information on keys used for encrypting data contained in a clip file in the associated clip information file (*.clpi) and writes key index information 403 for allowing access to the encryption key applied to each sequence in the information field AACS_Key_Index_Info( ).

The AACS_Key_Index_Info( ) field contains the number of AACS key sequences included in the associated clip file 401 and the start position of each sequence 402. In the example shown in FIG. 3, the values to be written in the sequence start position 402 of Clip File #1 are 0, a, and b. The key index information 403 contains information that points to CPS_Unit_number for Key_Index #i entries of the key file shown in FIG. 4, each of the entries storing the number of the CPS unit pointing to the position at which the associated encryption key is stored. A recording apparatus, therefore, can access a plurality of encryption keys used for encrypting data of a single clip file. A field 404 named AACS_Key_Index_Start_Address, which points to the start address of the AACS_Key_Index_Info( ) field, is stored at a predetermined position within the clip information file.

As a result, the titles recorded on a recording medium can be encrypted using different encryption keys. In the example shown in FIG. 3, Title #1 is encrypted with key 1, key 2, and key 3 and Title #2 is encrypted with key 4, key 5, and key 6. Likewise, Title #3 is encrypted with key 2 and key 5.

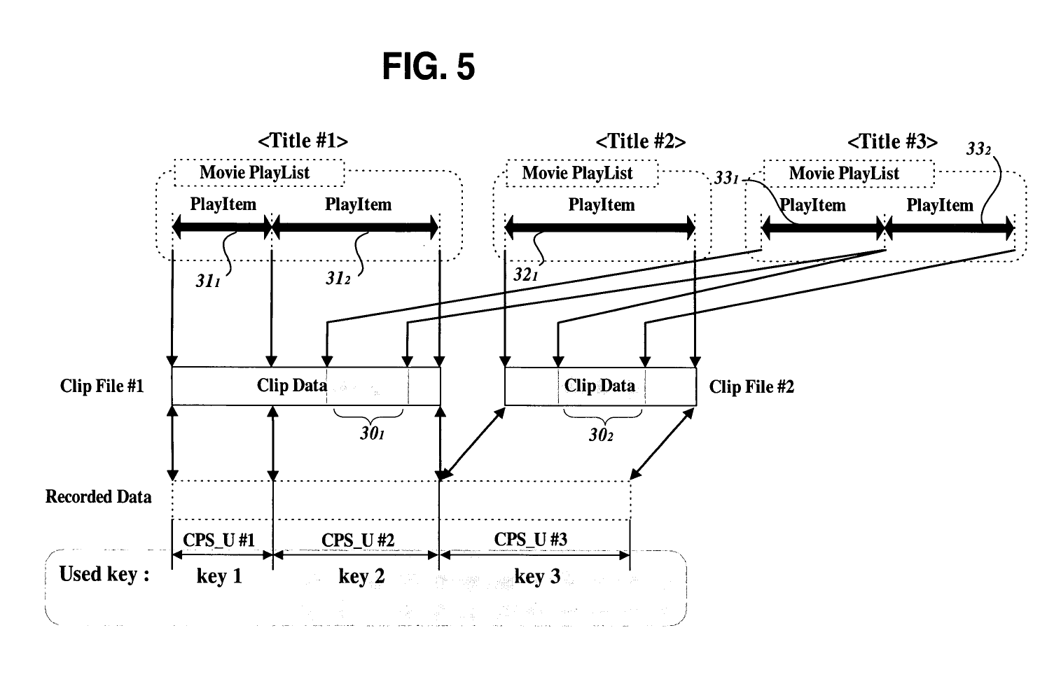

FIG. 5 shows an exemplary content recorded by applying a different encryption key to each CPS unit in accordance with another embodiment of the invention, wherein each data section corresponding to a playitem is organized as one CPS unit.

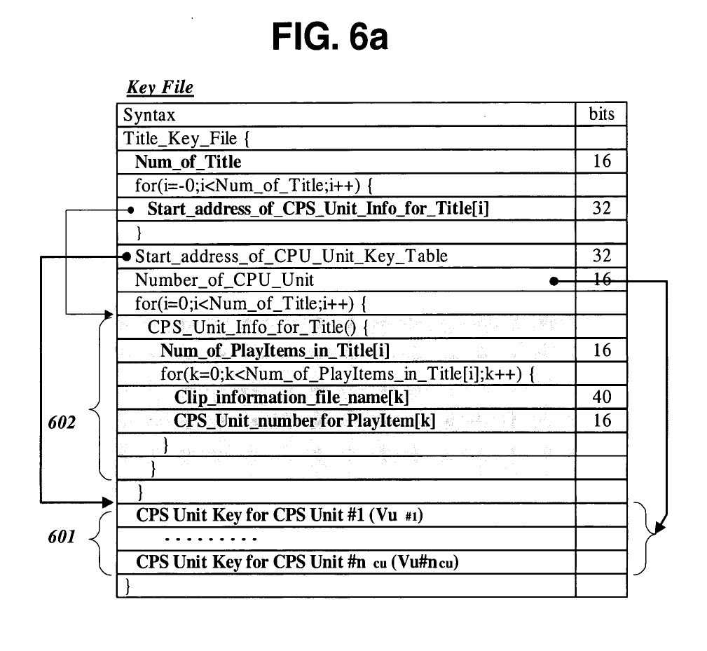

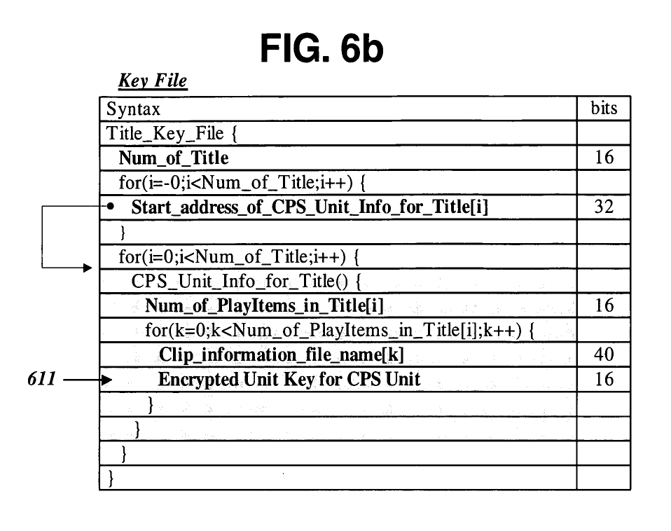

In this embodiment, the data section CPS_U #2, which is referenced by playitem 31₂ of Title #1 and includes data section 30₁ shared by different playitems, is encrypted with a single key, key 2, and the data section CPS_U #3, which is referenced by playitem 32₁ of Title #2 and includes data section 30₂ shared by different playitems, is encrypted with a single key, key 3. As a consequence, key 2 and key 3 are also stored in the key file for two playitems 33₁ and 33₂ included in Title #3. FIG. 6a shows the structure of an exemplary embodiment of the key file for allowing reproducing apparatuses to access the encryption keys.

In the embodiment of FIG. 6a, keys used for encrypting data of any titles are written in a key storage field 601 and index information for allowing access to keys used for encrypting data of a title is created for each of playitems belonging to the title and stored in the field 602. In the example shown in FIG. 5, key 1, key 2, and key 3 are written in the key storage field 601. Title #1 contains two playitems and thus is associated with two index information fields, CPS_Unit_number for PlayItem[k], which respectively store CPS unit numbers 1 and 2. Title #2 is associated with only one index information field which stores CPS unit number 3. Likewise, the index information fields, CPS_Unit_number for PlayItem[k], associated with Title #3 store CPS unit numbers 2 and 3.

The key file structure shown in FIG. 6a also includes address information Start_address_of_CPS_Unit_Info_{—for}_Title[i]), which points to the start address of information on CPS units in each title. The address information is intended for allowing reproduction apparatuses to rapidly access information on the start addresses of CPS units.

Unlike the embodiment shown in FIG. 6a which stores all the used keys collectively in the key storage field 601 and writes information for allowing access to the keys in each playitem, the exemplary embodiment shown in FIG. 6b stores an encryption key used for encrypting data referenced by each playitem separately for the playitem 611.

As a result, the titles recorded on a recording medium can be encrypted using different encryption keys. In the example shown in FIG. 5, Title #1 is encrypted with key 1 and key 2, Title #2 is encrypted with key 3, and Title #3 is encrypted with key 2 and key 3.

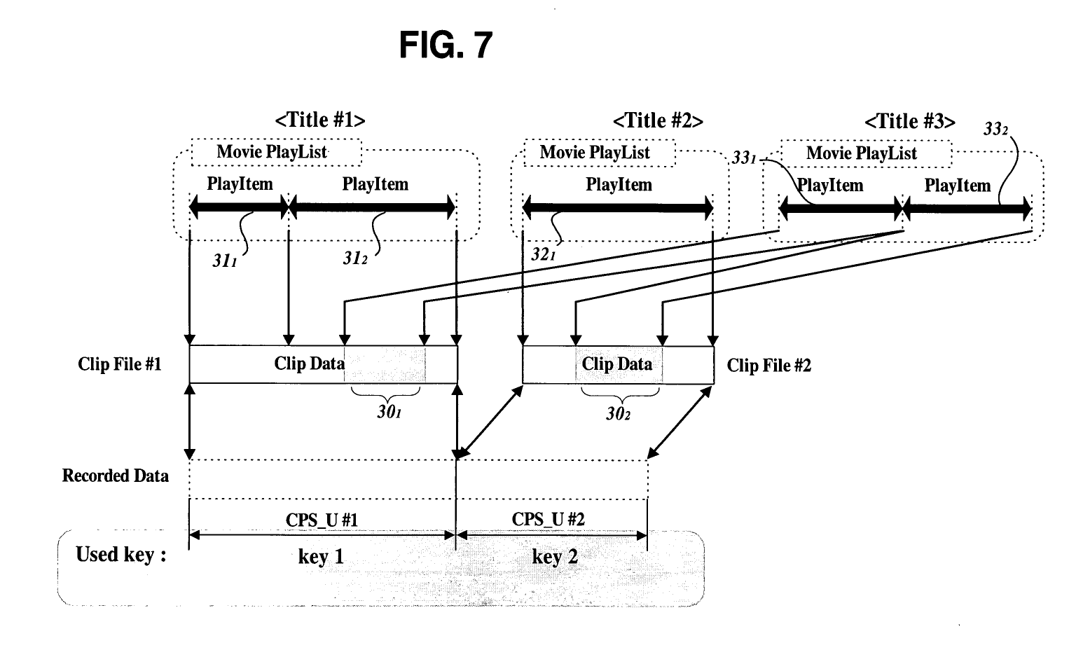

FIG. 7 shows an exemplary content recorded by applying a different encryption key to each CPS unit in accordance with yet another embodiment of the invention, wherein each clip file is treated as one CPS unit.

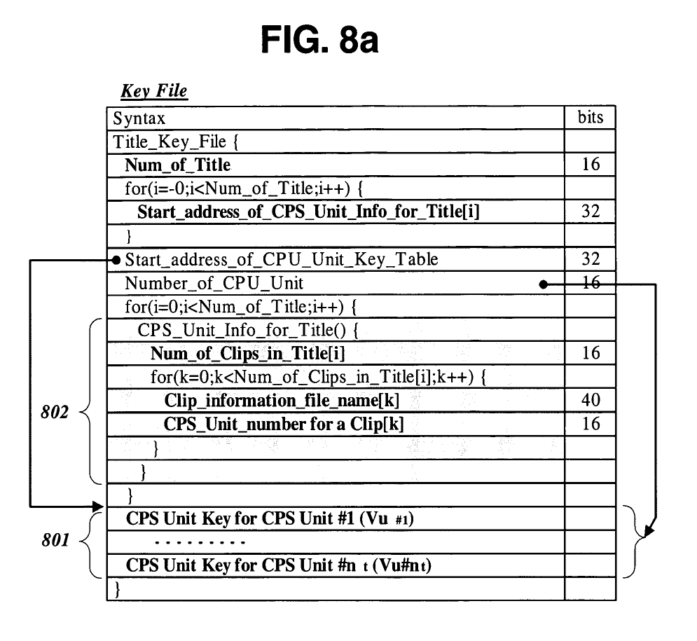

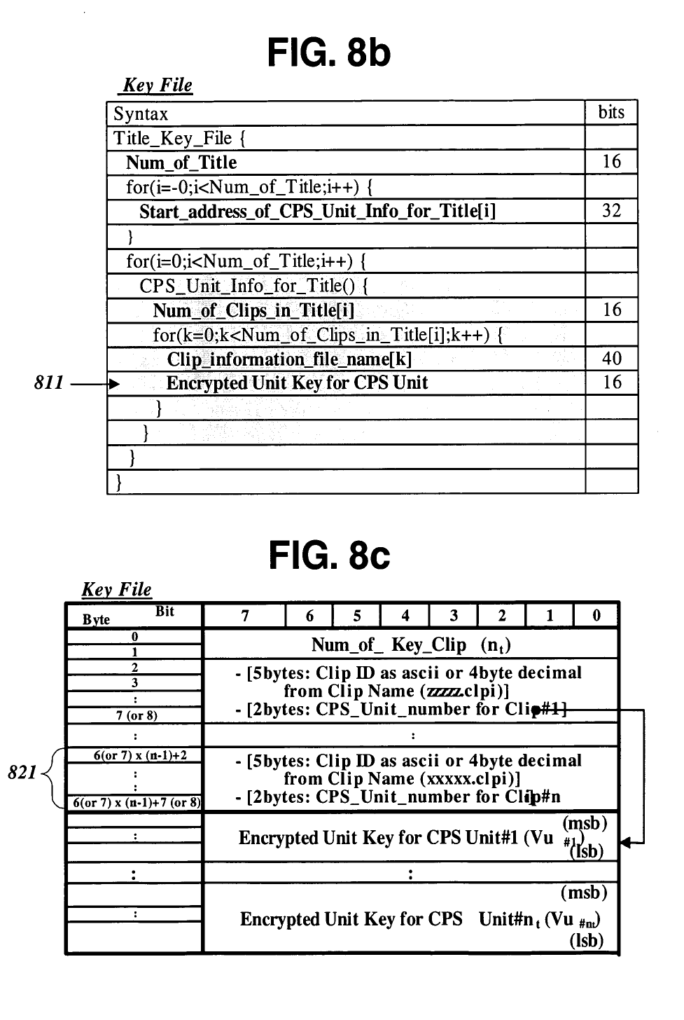

In this embodiment, each clip file is encrypted using a different encryption key. In the example shown in FIG. 7, there are two clip files which correspond to Title #1 and Title #2 and the two clip files are encrypted using two keys, key 1 and key 2. The playitems of Title #3 references data sections included in the two clip files and thus the keys used for encrypting the referenced data sections (i.e., key 1 and key 2) are stored in the key file. FIG. 8a shows the structure of an exemplary key file for allowing reproducing apparatuses to access the encryption keys.

In the embodiment shown in FIG. 8a, keys used for encrypting data of any titles are written in a key storage field 801 and index information for allowing access to keys used for encrypting data of a title (CPS_Unit_number for a Clip[k]) is created for each clip file belonging to the title. In the example shown in FIG. 7, key 1 and key 3 are written in the key storage field 801. The value of the CPS_Unit_number for Clip[k] field for Title #1 is written to 1 and the value of the CPS_Unit_number for Clip[k] field for Title #2 is written to 2. The value of the Num_of_Clips_in_Title[i] field for Title #3 is written to 2 and the values of the CPS_Unit_number for Clip[k] field for Title #3 are written to 1 and 2.

Unlike the embodiment shown in FIG. 8a which stores all the used keys collectively in the key storage field 801 and writes information for allowing access to the keys in each clip file, the exemplary embodiment shown in FIG. 8b stores an encryption key used for encrypting data of a clip file in the field 811 separately for the clip file.

FIG. 8c shows yet another embodiment of the key file which stores encryption keys used for each clip file. In this embodiment, information for identifying each clip file (e.g., the clip file name and the CPS number of the clip file) is stored in field 821 placed in the former part of the key file, the number of the pairs of the clip file name and the CPS number being identical to that of the clip files. The used encryption keys are collectively written in the latter part.

As a result, the titles recorded on a recording medium can be encrypted using different encryption keys. In the example shown in FIG. 7, Title #1 is encrypted with key 1, Title #2 is encrypted with key 2, and Title #3 is encrypted with key 1 and key 2.

In all the aforementioned embodiments, the recording controller 30 may encrypt the encryption keys with a mater key after recording all the encryption keys on the recording medium 23.

Encrypted data and information on the keys used for encrypting the data are recorded on a recording medium or a recording medium storing encrypted data and information on the keys used for encrypting the data is manufactured by the aforementioned procedure.

The method for reproducing a recording medium manufactured by the method described above will now be described.

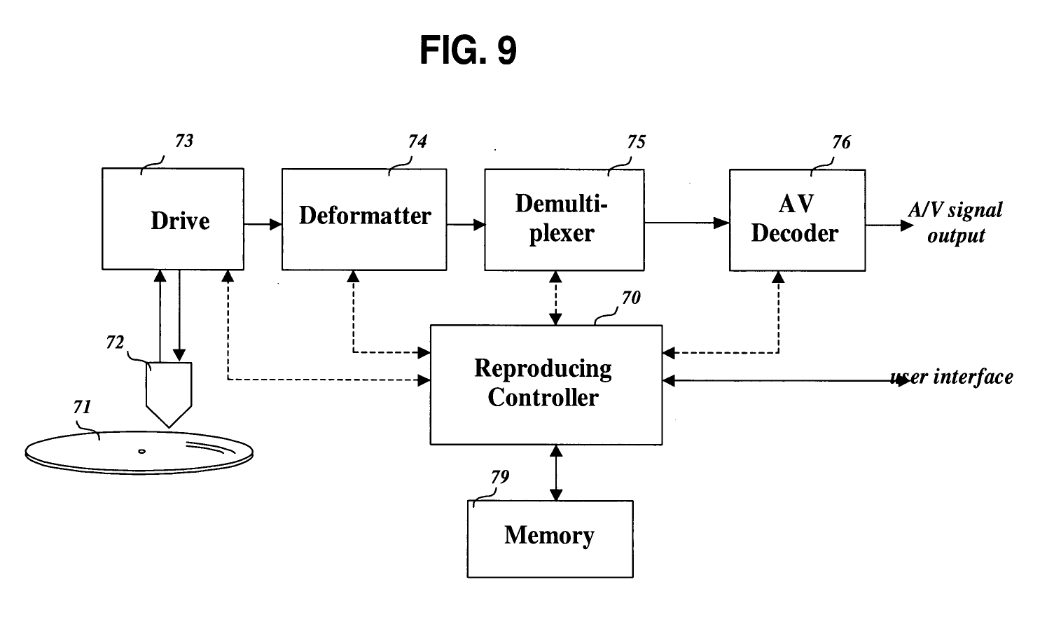

FIG. 9 shows a block diagram of an apparatus for reproducing a recording medium 71 storing encrypted content data and encryption information in accordance with the present invention. Receiving a reproduction request, a reproducing controller 70 first reads management information including navigation data through an optical pickup 72 by controlling a driver 73 and stores the management information in a memory 79. The management information includes an encryption key file having a structure as shown in FIGS. 4, 6a, 6b, 8a, 8b, or 8c.

The request for reproduction is made through a user interface (buttons on the reproduction apparatus, remote controller, etc) and user input can be entered through a graphical user interface based menu preprogrammed in the recording controller 30.

A deformatter 74 performs error correction operations on the reproduced data. Error corrected data is applied to a demultiplexer 75 if it contains A/V data. The error corrected data which is not A/V data (e.g., encryption information, navigation data, etc) is applied to the reproducing controller 70.

If the encryption keys stored in the key file is encrypted, the reproducing controller 70 decrypts the encrypted encryption key with a registered content provider's private key, which was obtained from the content provider and stored in an internal memory.

The reproducing controller 70 reads data segments of clip files corresponding to a title or titles specified by the reproduction request through the optical pickup 72 by controlling the driver 73. The demultiplexer 75 demultiplexes input data stream into encoded video and audio data. The A/V decoder 76 decrypts the encrypted data using encryption keys obtained by a method to be described later and decodes the decrypted A/V data to retrieve original video and audio signals.

During the reproduction process, the operation of the deformatter 74, demultiplexer 75, and A/V decoder 76 is supervised by the reproducing controller 70.

Each time the boundaries of CPS units are passed, the reproducing controller 70 acquires an encryption key associated with the next CPS unit from the memory 79 and provides the A/V decoder 76 with the encryption key. In the example shown in FIG. 3, a key file and clip information files (*.clip) as shown in FIG. 4 are loaded to the memory 79. The reproducing controller 70 acquires key index information (key_index[i]) which corresponds to the number of the AACS key sequence that begins to be inputted to the A/V decoder 76 from the clip information file and reads an encryption key (Encrypted Unit Key for CPS Unit #k) pointed to by the index information before providing the A/V decoder 76 with the encryption key.

In the example shown in FIG. 5, each of data sections referenced by playitems is organized as a CPS unit and a key file as shown in FIG. 6a or FIG. 6b is provided and loaded in the memory 79. The reproducing controller 70 reads all the encryption keys from the key file loaded in the memory 79 and provides the A/V decoder 76 with the encryption keys sequentially such that each CPS unit can be decrypted with an encryption key that was used to encrypt the CPS unit.

In the example shown in FIG. 7, each clip file is organized as a CPS unit and a key file as shown in FIG. 8a, FIG. 8b, or FIG. 8c is provided and loaded in the memory 79. The reproducing controller 70 reads all the encryption keys from the key file loaded in the memory 79 and provides the A/V decoder 76 with the encryption keys sequentially such that each CPS unit can be decrypted with an encryption key that was used to encrypt the CPS unit. In the embodiment shown in FIG. 8c, the file name of a clip file included in a title the reproduction of which is requested is first identified and the encryption key for the title is acquired through the CPS unit number which pairs with the file name.

In the preferred embodiments of the invention, the encryption information as shown in FIGS. 4, 6a, 6b, 8a, 8b, or 8c is recorded on a recording medium. However, it is also possible to store the encryption information in an external server associated with the content data recorded on the recording medium 71 with encrypting the content data in the same manner. If an reproducing apparatus equipped with communication capability transmits information identifying the content recorded on a recording medium, the external server determines whether the apparatus is authorized to reproduce the content data and provides the encryption information as shown in FIGS. 4, 6a, 6b, 8a, 8b, or 8c through a network.

The present invention efficiently protects the copyright of content data recorded on a high-capacity recording medium by allowing different titles recorded on a recording medium to be encrypted with different encryption keys even in the case where some data sections are shared by more than one title. Though an encryption key used for encrypting data of a title is revealed by some malicious methods, the data of other titles can be copy protected as long as the data is encrypted with other encryption keys.

While the invention has been disclosed with respect to a limited number of embodiments, those skilled in the art, having the benefit of this disclosure, will appreciate numerous modifications and variations therefrom. It is intended that all such modifications and variations fall within the spirit and scope of the invention.

What is claimed is:

1. A recording medium storing data, comprising:
a key file storing a plurality of encryption keys;
a plurality of data clips, each containing a data segment of content data encrypted with the plurality of encryption keys;
at least one piece of logical continuous playback unit information; and
a set of index information for indexing each of the plurality of encryption keys,
wherein the logical continuous playback unit information is linked to at least one data segment or a part of one data segment.

2. The recording medium of claim 1, wherein the logical continuous playback unit information is a title.

3. The recording medium of claim 1, wherein the set of index information is recorded in a distributive manner in a plurality of clip information files containing information on the plurality of data clips.

4. The recording medium of claim 1, wherein the set of index information is recorded in the key file.

5. The recording medium of claim 4, wherein each element of the set of index information includes a pair of information for allowing access to an associated encryption key and information for identifying a data clip.

6. The recording medium of claim 4, wherein each element of the set of index information includes information for identifying a data clip which is paired with an associated encryption key.

7. The recording medium of claim 4, wherein each element of the set of index information is created for each of data clips that belong to each piece of the logical continuous playback unit information.

8. The recording medium of claim 4, wherein each element of the set of index information is created for each of playitems that belong to each piece of the logical continuous playback unit information, each of the playitems pointing to a linked data section of a data clip.

9. The recording medium of claim 4, wherein the recording medium is a read-only recording medium.

10. A method for recording data on a recording medium, comprising the steps of:
(a) encrypting input content data by selectively using a plurality of encryption keys and recording the encrypted content data on the recording medium as a plurality of clip files, each containing a data segment of the encrypted content data;
(b) recording the plurality of encryption keys in a key file; and
(c) creating at least one piece of logical continuous playback unit information and a set of index information for indexing each of the plurality of encryption keys and recording the created at least one piece of logical continuous playback unit information and the set of index information on the recording medium,
wherein the logical continuous playback unit information is linked to at least one data segment or a part of one data segment.

11. The method of claim 10, wherein the logical continuous playback unit information is a title.

12. The method of claim 10, wherein the step (c) writes the set of index information in a distributive manner in a plurality of clip information files containing information on the plurality of data clips.

13. The method of claim 10, wherein the step (c) writes the set of index information in the key file.

14. The method of claim 13, wherein each element of the set of index information includes a pair of information for allowing access to an associated encryption key and information for identifying a data clip.

15. The method of claim 13, wherein each element of the set of index information includes information for identifying a data clip which is paired with an associated encryption key.

16. The method of claim 13, wherein the step (c) creates each element of the set of index information for each of data clips that belong to each piece of the logical continuous playback unit information.

17. The method of claim 13, wherein step (c) creates each element of the set of index information for each of playitems that belong to each piece of the logical continuous playback unit information, each of the playitems pointing to a linked data section of a data clip.

18. An apparatus for recording data on a recording medium, comprising:
an encrypting unit for encrypting input content data by selectively using a plurality of encryption keys;
a recording unit for recording data on the recording medium; and
a control unit for controlling the recording unit to record the encrypted content data on the recording medium as a plurality of clip files, for creating at least one piece of logical continuous playback unit information and a set of index information for indexing each of the plurality of encryption keys, and for recording the created at least one piece of logical continuous playback unit information and the set of index information on the recording medium by controlling the recording unit,
wherein the logical continuous playback unit information is linked to at least one data segment or a part of one data segment, the data segment being a part of the encrypted content data belonging to one data clip.

19. The apparatus of claim 18, wherein the control unit controls the recording unit to record the set of index information in a distributive manner in a plurality of clip information files containing information on the plurality of data clips.

20. The apparatus of claim 18, wherein the control unit controls the recording unit to record the set of index information in a key file.

21. The apparatus of claim 18, wherein the control unit creates each element of the set of index information for each of data clips that belong to each piece of the logical continuous playback unit information.

22. The apparatus of claim 18, wherein the control unit creates each element of the set of index information for each of playitems that belong to each piece of the logical continuous playback unit information, each of the playitems pointing to a linked data section of a data clip.

23. A method for reproducing encrypted content data from a recording medium, comprising the steps of:
(a) obtaining a key file storing a plurality of encryption keys and a set of index information for indexing each of the plurality of encryption keys;
(b) reproducing a plurality of data clips from the recording medium sequentially, each of the data clips containing a data segment of the encrypted content data; and
(c) selecting an encryption key from the key file based on an element in the obtained set of index information and decrypting data in a data section being reproduced using the selected encryption key, the element being associated with the data section pertaining to the content data.

24. The method of claim 23, wherein the plurality of data clips are linked to at least one piece of logical continuous playback unit information reproduction of which is requested by a user.

25. The method of claim 24, wherein the logical continuous playback unit information is a title.

26. The method of claim 23, wherein the step (a) reads each element of the set of index information recorded in a distributive manner in a plurality of clip information files containing information on the plurality of data clips.

27. The method of claim 23, wherein the step (a) reads the set of index information from the obtained key file.

28. The method of claim 27, wherein each element of the set of index information includes a pair of information for allowing access to an associated encryption key and information for identifying a data clip.

29. The method of claim 27, wherein each element of the set of index information includes information for identifying a data clip which is paired with an associated encryption key.

30. The method of claim 27, wherein each element of the set of index information is created for each of data clips that are linked to logical continuous playback unit information.

31. The method of claim 27, wherein each element of the set of index information is created for each of playitems that belong to logical continuous playback unit information, each of the playitems pointing to a linked data section of a data clip.

32. The method of claim 23, wherein the step (a) obtains the key file from the recording medium.

33. The method of claim 23, wherein the step (a) obtains the key file from an external server through a network.

34. The method of claim 23, wherein the data section is a content protection system unit.

35. An apparatus for reproducing encrypted content data from a recording medium, comprising:
a driver for driving optical reproduction means for reproducing data recorded on the recording medium;
a decrypting unit for decrypting the encrypted data read by the optical reproduction means; and
a control unit, responsive to a reproduction request, for obtaining a key file storing a plurality of encryption keys and a set of index information for indexing each of the plurality of encryption keys, for controlling the driver to reproduce entire or a part of the encrypted content data included in a plurality of data clips, for selecting an encryption key from the key file based on an element in the obtained set of index information, and for controlling the decrypting unit to decrypt data in a data section being reproduced using the selected encryption key, the element being associated with the data section pertaining to the content data.

36. The apparatus of claim 35, wherein the plurality of data clips are linked to at least one piece of logical continuous playback unit information reproduction of which is requested by a user.

37. The apparatus of claim 36, wherein the logical continuous playback unit information is a title.

38. The apparatus of claim 35, wherein each element of the set of index information is created for each of data clips that are linked to logical continuous playback unit information.

39. The apparatus of claim 35, wherein each element of the set of index information is created for each of playitems that belong to logical continuous playback unit information, each of the playitems pointing to a linked data section of a data clip.

40. The apparatus of claim 35, wherein the each data section is a content protection system unit.
